(19) United States
(12) Patent Application Publication
(10) Pub. No.: US 2017/0130694 A1
(43) Pub. Date: May 11, 2017

(54) ROTATING BLADE BODY FOR TURBINES USING THE MAGNUS EFFECT, IN PARTICULAR TURBINES WITH AN AXIS OF ROTATION PARALLEL TO THE DIRECTION OF THE MOTOR FLUID

(71) Applicant: Antonio LA GIOIA, Marino (IT)

(72) Inventor: Antonio LA GIOIA, Marino (IT)

(21) Appl. No.: 15/318,080

(22) PCT Filed: Jun. 15, 2015
(86) PCT No.: PCT/IT2015/000152

§ 371 Date: Dec. 12, 2016

(30) Foreign Application Priority Data
Jun. 13, 2014 (IT) RM2014A000312

(51) Int. Cl. F03D 1/06

(52) U.S. Cl. CPC F03D 1/0616; F05B 2240/201; F05B 2250/70

(57) ABSTRACT

The present invention relates to a rotating blade body for turbines using the Magnus effect with an axis of rotation of the turbine parallel to the direction of the motor fluid, characterised in that it is defined by a first sector or end head, more distant from said axis of rotation of the turbine, and by a second sector or rod, connecting said first sector and said axis of rotation of the turbine, said second sector having an average diameter smaller than the diameter of said first sector, said first sector being inscribed within a solid of revolution whose profile is determined so as to maintain a constant value of lift in each section.

The present invention relates to a rotating blade body for turbines using the Magnus effect, in particular with axis of rotation of the turbine parallel to the direction of the motor fluid.

More specifically, the invention concerns the definition of the construction technique of the blade bodies animated with rotary motion with respect to their longitudinal axis, installed in hydraulic and wind turbines operating according to the dynamic effect known as the Magnus effect.

In particular, the invention refers to a rotating blade body for axial turbines, with the expression axial turbine being indicated a turbine with an axis of rotation parallel to the direction of the motor fluid.

As is well known, there is a correlation between the spin of a rotating cylinder with respect to its longitudinal axis and the fluid stream which strikes said cylinder in a direction perpendicular to said longitudinal axis. Such a correlation has been described, in 1852 for the first time, by HG Magnus, and for this reason it is called the Magnus effect.

This correlation is highlighted on the lateral skirt of the cylinder with a force, called “lift”, in a direction perpendicular to the lines of flow of the fluid stream, and rotated in a clockwise or counterclockwise direction with respect to said stream, depending on the direction of rotation of the cylinder; more in particular it is rotated in a clockwise direction when said cylinder rotates counterclockwise and it is rotated in a counterclockwise direction when said cylinder rotates clockwise.

Quantitatively, the modulus of the lift L (expressed in N/m), per unit length of the cylinder, is given by the equation of Kutta-Joukowski, and is equal to the product of the density of the fluid ρ (expressed in kg/m³), for the asymptotic speed V₀ of the fluid threads (expressed in m/s), ie the speed of the fluid threads where the same move undisturbed, and for the circuitry Γ (expressed in m²/s).

In formulas, if the cylinder has radius (expressed in m), the lift due to the Magnus effect is determined by the relation:

L=ρ·V₀·Γ=ρ·V₀·2π·ω·R²=2π·ρ·V₀·(ω·R²) (1)

This relation is independent from the shape of the profile, ie it is valid for any profile, by profile being meant the contour of the rotating body along a section plane passing through the rotation axis of the rotating body.

The U.S. Pat. No. 1,674,169 assigned to the Instituut vor Aero-Hydro-en Dinamiek, inventor Anton Flettner, describes several possible applications of Magnus effect, in particular as “sails” for a boat and as “blades” of a wind generator, and presents various alternative embodiments of the rotating bodies, including in particular the cilindric shape (in the patent several boats are shown equipped with a “sail” constituted by a cylindrical rotating body, but it is also shown a wind generator with a rotation axis parallel to the wind direction, in which each blade body is formed by four cylinders of circular cross-section and an increasing diameter, starting from the hub towards the end), the ellipsoidal shape (referred to only in a figure relating to a boat without describing its peculiarities) and a shape consisting of two frustoconical portions mutually connected by a cylindrical portion (also in this case without any description that specifies dimensional relationships between these portions). Referring to the wind generator, in it the ratio between the diameter of the turbine wheel and the diameter of the blade body, also called aspect ratio L/D, is equal to 23.

In U.S. Pat. No. 4,366,386, TF Hanson presented an axial wind turbine, with three cylindrical blade blade bodies functioning according to the Magnus effect. In this case, the aspect ratio L/D is equal to 15.

The European patent N. 886 728 describes a turbine blade where the bodies, referred to as “chiral”, rotate around their longitudinal axes positioned radially around the central power axial hub, presenting a generic form called: “bulbous shape”. The profiles of these “bulbar blade bodies” are not defined, ie, the description of these “bulbar blade bodies” lacks of geometric references of realization supporting the advantages in terms of fluid dynamics related to the choice of the profile, aimed at improving the engineering of the bulbar blade.

Moreover, in European patent N.886728 it is stated that the optimal geometrical configuration of the blade bodies is derived from data provided by a computer through a numerical simulation of an experimental model, taking into account the aerodynamic and mechanical needs, which means to start, from time to time, a specific analysis of CFD (Computational Fluid Dynamics), which provides very complex calculation tools, as in the case of a real fluid the viscosity intervenes in calculation, which modifies the coefficients of lift and drag.

The same generics on the geometry of the profile characterise the PCT application No. WO2002/042640. In fact, in this case also the blade forming object of the invention is described as an axial-symmetrical body designed according to a generic “cylindrical-conical” form, but no details are given about the constructive features and the improvements in the fluid-dynamic field, due to the proposed new blade geometry.

In 2009, the German Enercon, one of the largest manufacturers of wind turbines, launched a cargo ship, 130 m long, 22.5 m wide and with 10500 metric tons deadweight (DWT), equipped with four Magnus effect cylinders 25 m high and 4 m in diameter, to integrate, with a saving of 40%, the traditional propulsion propellers.

In the years between 1930 and 1950, Marco Todeschini studied and experimented the Magnus effect and finally edited “La Teoria delle Apparenze (Spazio-Dinamica & PsicoBiofisica)”, published by Istituto Italiano d'Arti Grafiche in Bergamo in 1949, as well as “Psico-Biofisica”, Ed. Centro Int. di Psicobiofisica, Bergamo, 1949, setting out an innovative interpretation of Magnus effect, based on dynamic considerations and corroborated by experiments made in a ship model basin; determining that the effects of attraction and repulsion which are observed on two cylinders parallel to each other, and due to their rotation about their respective longitudinal axes, are connected to the inertia of the earth: that is, the spin of the Earth.

Starting from this interpretation, the international application WO2014049627, on behalf ER Renewable Energy, inventor Antonio La Gioia, gives a more general justification of this theoretical-experimental thesis, making reference to inertial forces activated by the Magnus dynamic process, and, in turn, considered and mathematically explained in the theorem of circuitry of Kutta-Joukowsky, revisited according to a relativistic interpretation which considers the rotational movement of the Earth, ie moves the observation point in a triad of references located outside the terrestrial triad reference system, in order to attribute to the coaxial reference system, as it actually is, two movements of the Earth: its revolution around the Sun and its rotation (spin) around its axis.

On the basis of this interpretation, in the International application WO2014049627 it is proposed a rotating blade body for turbines using the Magnus effect which is capable of exploiting the Magnus effect in an optimized way, in view of the contribution of the Earth's rotation. In particular, WO2014049627 discloses a rotating blade body for turbines using the Magnus effect with an axis of rotation of the turbine parallel to the direction of the motor fluid, characterised in that it is defined by a first sector, more distant from said axis of rotation of the turbine, and by a second sector, connecting said first sector and said axis of rotation of the turbine, said first sector being circumscribed within a first ovoid of construction of Rankine-Fuhrman, with minor axis (D₁) comprised between ⅕ and ⅙ of the diameter (Ø) of the turbine axis and with major axis (L₁) equal to 10 times said minor axis (D₁), said first sector having a larger diameter at its point farthest from said axis of rotation of the turbine and equal to D₁ and length at least equal to said larger diameter; said second sector, of connection between said first sector and said axis of rotation of the turbine, being circumscribed within a second ovoid of construction of Rankine-Fuhrmann, with a major axis (L₂) corresponding to the diameter (Ø) of the turbine and with minor axis (D₂) equal to 1/10 of said major axis (L₂), said second sector (12) having a larger diameter at its point farthest from said axis of rotation of the turbine and a length equal to the distance between said first sector (D₁) and said axis of rotation of the turbine.

In the latter patent, as in the previous, it is maintained an approach that favors the mechanical aspects of torque and moment with respect to the axis of the impeller, arriving to define a profile tapered towards the axis of the rotor itself, to get the maximum power permitted by the coefficient of lift, according to the aforementioned equation

L=ρ·V₀·Γ=ρ·V₀·2π·ω·R²=2π·ρ·V₀·(ω·R²)

By contrast, it is known that in the aeronautical sector, the blades of the propellers are often made with a geometry such as to ensure a constant lift, both in sections close to the hub, and in those of extremity, more and more swerving the profile of the starting from the end down to the hub. This choice brings undoubted advantages from the point of view of mechanical strength of the blade, which is not subjected to differential stresses along its length.

In light of the above, it appears evident the need for Magnus effect machines designed taking into account all the components that affect said effect, at the same time ensuring the constancy of the lift.

In this context it is included the solution according to the present invention, aiming to provide rotating bodies, also defined blade bodies considering their application as turbine blades with an axis of rotation of the turbine parallel to the direction of fluid flow, ie with axis of rotation of the blade bodies perpendicular to the direction of the fluid flow, having peculiar profiles, different from those considered in accordance with the prior art. These blade bodies are proposed for the construction of wind or hydraulic turbines, operating both in flowing waters and in closed circuits.

In the range of current technological choices of cylindrical and axial-symmetric blade shapes, with variable profile but still tapered proceeding towards the impeller, the present invention proposes therefore to provide significant improvements, both in the field of industrial engineering and as regards the reduction of passive forces, relating to the movement of blade bodies, thus promoting the increase of power output.

These and other results are obtained according to the present invention suggesting a rotating blade body for turbines using the Magnus effect, in particular with axis of rotation of the turbine parallel to the direction of the motor fluid, the profile of which is obtained by making reference to the necessity of maintaining a constant lift, said lift being determined as a function of the relationship between the “spin” of the cylinder and the speed of the undisturbed wind, after processing of fluid dynamic parameters, in order to fit to a configuration built on the profile of ovoidal bodies with precise ratios of length and width, widely experienced in the aviation industry, as regards the coefficients of lift and drag, and in particular, but not necessarily, on the profile of the ovoid of Rankine-Fuhrmann, applied in the realization of the airships, as well as on its standardized variants of simpler industrial feasibility (NACA profiles).

In this way it is possible to ensure the reduction of all those terms that subtract power to the axis, such as for example:
the term due to the friction of the flow on the outer surface of the blade body;
the term which expresses the losses of the electric motor that generates the rotation of the blade bodies;
the term which expresses the friction losses in the transmission and support members: gearwheels and bearings.

It is also possible to ensure:
a standard to be applied in industrial production lines;
a reduction in the energy dissipated and lost in the power lines due to wake vortex separation.

The purpose of the present invention is therefore to provide a rotating blade body for turbines using the Magnus effect, in particular with axis of rotation of the turbine parallel to the direction of the motor fluid which allows to overcome the limits of the solutions of the prior art and to obtain the technical results described above.

Further object of the invention is that said blade body can be manufactured with costs substantially limited, both as regards production costs and as regards the costs of management.

Another object of the invention is to provide a rotating blade body for turbines using the Magnus effect with axis of rotation of the turbine parallel to the direction of the motor fluid that is substantially simple, safe and reliable.

It is therefore a specific object of the present invention a rotating blade body for turbines using the Magnus effect, in particular with axis of rotation of the turbine parallel to the direction of the motor fluid, as defined in claim 1.

Additional characteristics of the blade body according to the present invention are defined in the dependent claims 2-8.

The present invention will be now described, for illustrative but not limitative purposes, according to its preferred embodiments, with particular reference to the figures of the accompanying drawings, in which:

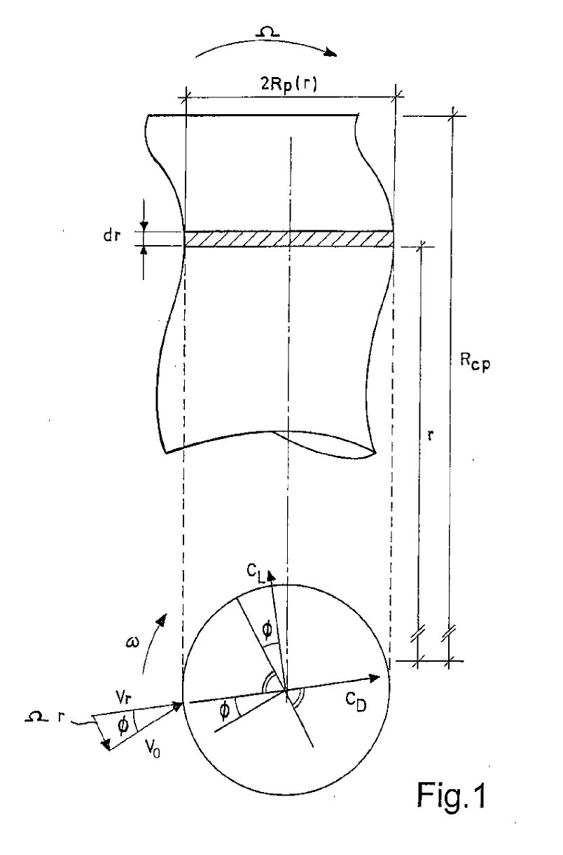

FIG. 1 shows schematically a blade body having a random shape, used to calculate the maximum achievable power;

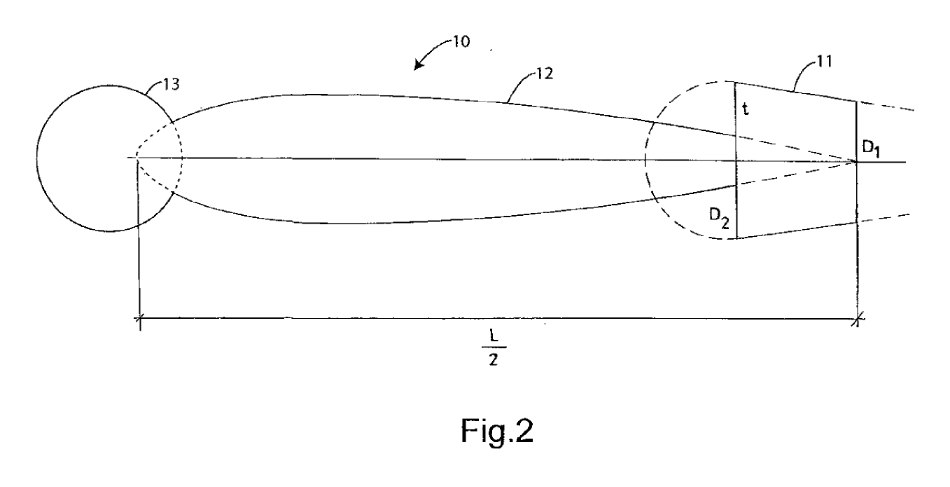

FIG. 2 shows a section view of the basic form of the rotating blade body for turbines using the Magnus effect according to a first embodiment of the present invention, and its construction lines, and

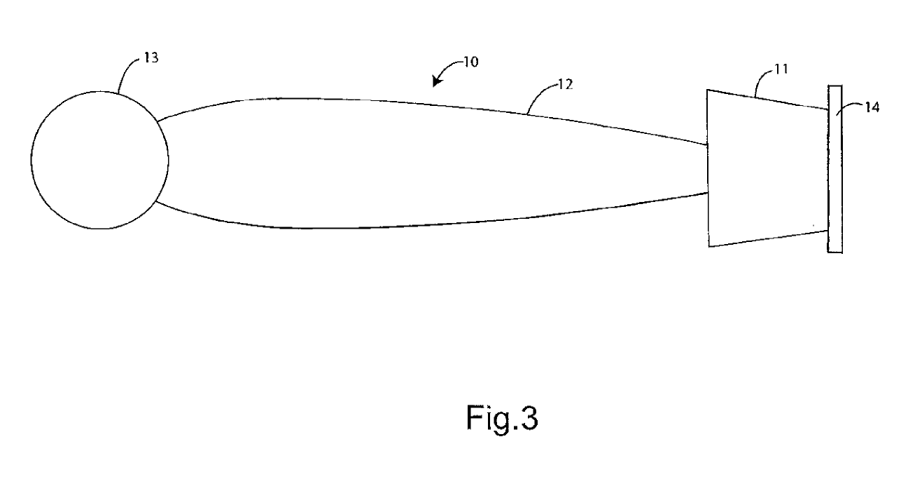

FIG. 3 shows a side view of a rotating blade body for turbines using the Magnus effect in accordance with the basic form of the rotating blade body of FIG. 2.

As already described earlier, the norm of lift L (expressed in N/m) per unit of length of the cylinder, is given by the equation of Kutta-Joukowski, and is equal to the product of the density of the fluid ρ (expressed in kg/m³), by the asymptotic speed of the fluid threads V₀ (in m/s), ie the speed of the fluid threads where the same move undisturbed, and by the circuitry Γ (expressed in m²/s). If the cylinder has a radius R (expressed in m), the lift L due to the Magnus effect is determined by the equation:

L=ρ·V₀·Γ=ρ·V₀·2π·ω·R²=2π·ρ·V₀·(ω·R²) (1)

This relationship is independent of the shape of the profile, by profile being ment the contour of the body hit by the fluid current.

This formula is valid for a body that does not move in a fluid current, and does not interact with this, so it is possible to make reference to the asymptotic/undisturbed speed V₀.

This is the case, by way of example, of the model in similarity or model of Reynolds or Froude, of an aircraft wing tested in the wind tunnel.

When, on the contrary, the blade body of a turbine using the Magnus effect is considered, which interacts with the fluid vein, being animated by its spin, and simultaneously rotates with respect to an axis of rotation around the turbine impeller, reference must be made to the relative velocity Vᵣ.

Referring to FIG. 1, for any section of the blade body at a distance r from the hub, having a generic thickness (dr) and a generic radius Rₚ function of r, the relative speed Vᵣ has the following expression:

(Vᵣ)²=(Ω·r)²+(V₀)² (2)

where Ω is the angular velocity of the impeller, and Ω·r is the tangential velocity of the generic section of the blade body, placed at a distance r from the rotation axis of the turbine.

So, Vᵣ decreases section by section, coming down to the hub of the wheel-turbine.

Substituting this expression in the relation of lift it is obtained:

L=ρ·Vᵣ·2π·ω·Rₚ² (3)

From the latter relation descend the choices underlying the present invention, so as to obtain a profile that ensures a constant lift, in both end sections, which are the most effective, since they are more distant from the hub, and in those of fitting that are met proceeding towards the hub.

In the relation (3), expression of the lift, appears the product of two terms: Vᵣ·Rₚ², the first of which decreases going towards the hub.

It follows that, for keeping constant the lift, expressed in N/m, it is not possible to proceed, going towards the hub, with a tapered profile, as has always been proposed in the prior art, but, to the contrary, it is necessary to choose blade bodies which have the shape of a surface of rotation, described by any equation, and which have profiles with radiuses Rₚ that are variable from section to section, proceeding from smaller radiuses, at the ends, to greater radiuses, proceeding towards the hub, as shown in FIGS. 2 and 3.

In this way, the contribution of the radius Rₚ, being squared, even by varying in small increments, can limit the decrease of Vᵣ. Therefore it is possible, in a program of numerical modeling, to vary the product Vᵣ·Rₚ² towards constant values, by acting on the term that is squared, and that describes the generating profile of the blade body.

The considerations underlying the construction of a blade body of an axial turbine using the Magnus effect according to the present invention.

The fundamental principle of study used to simulate the dynamic reality of the aerodynamic behavior of a body is the one in which sources and wells interact with a fluid stream animated with uniform motion with asymptotic velocity V₀ or V∞.

The sources are represented as physical-mathematical point entity, from which a flow springs that spreads in the area crossed by the stream of fluid with uniform motion, while the wells (sinks) are summarized as mathematical-physical point entities where a flow disappears.

In the case in which the stream having uniform velocity V₀ or V∞ invests only a source of given intensity, it opens upstream of the source, and between the new trajectories of the stream lines the stream line is shown which, starting from a point of stagnation positioned upstream of the source, on an axis z parallel to the stream direction and passing through the source, it is arranged in such a way as to draw an open profile named “semi-infinite ogive of Rankine”.

If the fluid stream with asymptotic velocity V₀ or V∞ first meets a source of assigned intensity and subsequently a sink of equal and opposite intensity, the source and the sink being lined on the z axis, the stream lines open and then close, ie it is possible to obtain two singular points, called points of stagnation, the first upstream of the source and the second downstream of the sink, and a stream line flowing through both and that before and after these points of stagnation coincides with the z axis.

The closed surface, which is obtained by rotating this stream line through 360° about the z axis defines the shape of a three-dimensional axial symmetric body of predetermined length which, located in the considered stream, reproduces exactly the field of motion outside said stream line. That means that the profile of this body, formed by the revolution of the line of stream generated by the presence of the source and of the sink, if entered into the stream flow, does not alter the flow pattern changed by the flow of the source and the sink. A body with this form is called “solid of Rankine” or “ovoid of Rankine.”

If the sink is distributed in an infinite sequence of sinks, called “sheet of sinks,” such as to absorb point by point the same flow distributed by an infinite number of sources, called “sheet of sources”, the body drawed within this combination “sheet of sources”-“sheet of sinks”, invested by a plain stream of asymptotic velocity V₀ or V∞, has a symmetrical profile which is a stream line passing through the points of stagnation. This profile is called “symmetric profile of Rankine-Fuhrmann.”

The general equation of that profile, given its difficulty, is solved by iteration speculating each time a value of the flow rate per unit length distributed by the “sheet of sources” and absorbed by the “sheet of sinks”, capable of satisfying the integral equation of the profile. This method was developed by Rankine and then applied in a systematic way by Fuhrmann, who determined the forms corresponding to different distributions. The so-called penetrating solids of Fuhrmann were also identified, and this denomination is due to the low drag coefficient that characterizes these solids, because their profiles accompany the stream gradually and consequently have a very contained trail, unlike a bluff body, such as a cylinder, which presents a very large trail, characterized by the presence of vortices which are detached and subtract energy to penetration of the body in the fluid.

According to the present invention, therefore, the trend of the generating profile of the turbines of the models and prototypes of industrial production, will be that of an ovoidal object, not excluding the symmetrical profile of Rankine-Fuhrmann, which, from time to time, can be identified by a pair source-sink the flow rates of which, both that emitted and that absorbed, are equal and opposite, to have a contour line closed and representative of the ovoidal body.

The distance between the two extremes of stopping (stagnation) of the ovoidal object represents the length of the ovoidal object.

To determine the flow rates of the source and the sink so that the resulting gene rating ovoidal object has determined length, corresponding, in the case under analysis, to the diameter L (expressed in meters) of the turbine, it is necessary to fix the value of the asymptotic speed V₀.

In case an ovoidal blade body is desired, for example according to the symmetrical profile of Rankine-Fuhrmann, and that the length L is, for example, 10 times the width H, the algebraic solution of the problem is very complex, therefore it is necessary to operate by successive approximations.

The way that is proposed according to the present invention, in this case of a ratio 10:1, is the following.

The distance d between the sink and the source is fixed, as being equal to 9H

d=9H

Then it is hypothesized the link between the asymptotic speed V₀ (in m), the flow rate q of the source, per unit length of the source (in [m³/s]:[m]), and the induced speed u, outgoing from the source:

q=H·(V₀+u)

where u=2q/(2nd/2)
In this way it is found, with simple algebraic steps, the relationship that provides the flow rate as a function of the asymptotic speed and of the width H:

q/V₀=1,076H

In this report we introduce and the aspect ratio provided by the experiment minds of machines known Magnus effect, which Flettner ship, one of Cousteau and Enercon-Ship:

ψ(φ/D)=5÷6

where φ is the diameter of the turbine and D is the diameter of the head of vane ends.

This leads, for ψ=5, the relationship:

q=0.2015·φ·V

These data can be entered in a program of numerical modeling that allows to verify, for subsequent attempts, all relating to the first basic assumption, the value of

d=f(H)

if the ovoidal body that is formed when the asymptotic flow hits the air flow from the source, it assumes step by step, the size of the ovoid, which was assumed to be equal to the ratio 10:1.

To simplify the construction of the blade body according to the present invention it is possible to use NACA profiles, suitably adapted, for similarity, to the structure defined above. In fact, in this way it is possible to use a profile copied and derived from a standardized biconvex symmetrical profile or alternatively by a standardized plano-convex profile, uniquely identified, of which the lift and drag are known, when used as an airfoil, and that will then studied in a program of numerical modeling.

From the above, and referring to FIGS. 2 and 3, the rotating blade body 10 for turbines using the Magnus effect according to the present invention has the profile of extremity 11, also said end head, derived from a noble figure which is the ovoid of Rankine-Fuhrmann, tested in aviation industry, and contained between two sections:
the outer one, the diameter D₁ of which is derived from the classic ratio L/D=6/6.5;
the inner one, the diameter D₂ of which is derived from the classic ratio L/D=4.5/5.

Continuing towards the axis of rotation, the connecting body 12, also said stem, simulates a biconvex symmetrical NACA profile, which presents the trailing edge of small dimensions, connected with the upper part, and then continues towards the hub 13 with increasingly larger sections until reaching the largest dimensions in correspondence of the leading edge.

This profile has, therefore, sections with a greater radius, closer and closer to the hub 13, and this goes to make up for the decrease in the relative speed Vᵣ, the expression of which contains the radius of the blade body, squared.

Additionally, having in the vicinity of the hub 13 greater sections, it is also possible to overcome, in the smaller turbines using the Magnus effect, the difficulty of insertion of motor engine, advantageously provided in each blade body 10.

The drawing of the blade body 10 is completed by the end plate 14 which has a double task:
the first, keeping the center of effort towards the high, to increase the motor torque of useful force;
the second, to limit, in the vicinity of the blade body 10, the regime of turbulence due to the detachment of the vortex, from which derives the drag.

Finally, differently from cylindrical blade bodies, in the turbine using the Magnus effect according to the present invention, starting from the hub 13 and going to the extremity, the area which is offered to the fluid flow is likely to promote a Venturi effect.

### Example. Construction of the Profile of a NACA Standardized Blade Body

Referring to FIG. 2, to take advantage of a normed profile that effectively approximates to the ideal one previously described, the rotating blade body 10 for turbines using Magnus effect according to the present invention can be obtained starting from the design of the stem 12, made starting from symmetrical biconvex NACA profiles 00XX, such as for example: 0012; 0015; 0024; 0030; or: from plan-convex NACA profiles, obtained by a 360° rotation, around the line of the belly of the profile, so as to be capable of covering the NACA profiles of the stem 12, for example, 0012; 0015; 0024; 0030.

As far as the end head 11 is concerned, once the bases have been defined, the smaller outer base having diameter D₁ equal to L/6; and the greater inner base having diameter D₂ equal to L/5, having indicated with L the diameter of the turbine, as deduced from the canonic ratios used in the marine field by Flettner, Cousteau and Enercon-Ship, it is possible to conveniently connect the endpoints of these two bases with profiles that are counterparts of the profile of the stem of which the equativo is known, being a standardized NACA profile.

In a simplified description it is possible to say that in a turbine using Magnus effect with a diameter L=300 cm, the stem 12 which starts from the hub 13 is a NACA 0030 that has the maximum thickness equal to (30/100)·150=45 cm.

In the point of exit of the profile it is drawn a line perpendicular to the center line of the NACA 0030, and on this line it is taken a segment D₁ equal to L/6=300/6=50 cm, according to the experimental results of Flettner. This segment constitutes the smaller base of the head end.

The greater base is to the left of the smaller base, at a distance d from it that amounts preferably, but not necessarily, to L/5, or L/6, or L/6·1.618.

The diameter D₂ of the larger base is set equal to the maximum thickness t of a new NACA profile 00XY, whose equation is

$${y}_{t} = \frac{t}{0.2} c [ 0.2969 \sqrt{\frac{x}{c}} - 0.1260 ( \frac{x}{c} ) - 0.3516 {( \frac{x}{c} )}^{2} + 0.2843 {( \frac{x}{c} )}^{3} - 0.1015 {( \frac{x}{c} )}^{4} ] .$$

where:
c is the length of the chord,
x is the position along the chord from 0 to c,
y is half the thickness at a given value of x (center line of the surface), and
t is the maximum thickness expressed as a fraction of the chord (therefore 100·t gives the last two digits XY in the NACA 4-digit name).

It must be noted that in this equation, the point where x/c=1 (ie at the trailing edge of the airfoil), the thickness is not exactly zero. If it is required a trailing edge thickness equal to zero, for example for the calculation work, one of the coefficients must be modified in such a way that the sum is equal to zero. The modification of the last coefficient (ie the one with a value of −0.1036) involve the slightest change to the overall shape of the airfoil.

The leading edge approximates a cylinder with a radius:

r=1.1019t².

The coordinates (x_{U},y_{U}) of the top surface of the blade and (x_{L},y_{L}) of the lower surface of the blade are:

x_{U}=x_{L}=x, y_{U}=+yₑ, and y_{L}=−yₜ.

Referring to FIG. 3, the blade body 10 is completed by an end disk 14, also called end plate, with a diameter D₃ greater than D₁ and preferably comprised between 1.25 and 1.35 D₁, more preferably equal to 1.35 D₁.

The end plate 14 has the task to increase the lift of the blade body 10, reducing the vorticity of the fluid threads of the extremities, and its diameter D₃ is equal to k·D₁, where k depends on the ratio between the spin velocity of the rotating blade body and the resultant velocity Vᵣ incident on the blade body.

In this way it was realised a blade body of excellent solidity, which is comparable to naval propellers, having low values of the aspect ratio L/D=5÷6; and low values of spin, on average comprised between 300 and 700 rpm, with peak values of about 2000 rpm for prototypes having diameters equal to three meters.

The clear separation between the two sectors, one that starts from the hub 13, which is the stem 12 and the end head 11, strengthen the task of the end disk 14, causing the rapid decay of secondary vortices degenerating into bulges, when the main vortex is detached and moves downstream, for the increase of the spin (M. H. Chou “Numerical study of vortex shedding from a rotating cylinder immersed in a uniform flow field”).

The present invention has been described for illustrative but non limitative purposes, according to its preferred embodiments, but it is to be understood that variations and/or modifications can be apport by those skilled in the art without departing from the relevant scope of protection, as defined by the enclosed claims.

1) Rotating blade body for turbines using the Magnus effect with an axis of rotation of the turbine parallel to the direction of the motor fluid, characterised in that it is defined by a first sector or end head, more distant from said axis of rotation of the turbine, and by a second sector or rod, connecting said first sector and said axis of rotation of the turbine, said second sector having an average diameter smaller than the diameter of said first sector, said first sector being inscribed within a solid of revolution whose profile is determined so as to maintain a constant value of lift in each section, where the lift L is defined by the relation:
L=ρ·Vr·2π·ω·Rp2 (3)
where L is the lift (N/m), ρ is the fluid density (kg/m3), ω is the angular velocity of rotation of the blade body about its axis, Rp is the radius of the section and is a function of r, which is the distance from the axis of rotation of the turbine and Vr has the following expression:
(Vr)2=(Ω·r)2+(V0)2 (2)
where Ω is the angular velocity of the impeller, and Ω·r is the tangential velocity of the generic section of the blade body, placed at a distance r from the axis of rotation of the turbine and V₀ is the asymptotic speed of the fluid fillets (in m/s).

2) Rotating blade body according to claim 1, characterised in that said second sector is inscribed within a solid of revolution whose profile is determined so as to maintain a constant value of lift in each section, where the lift L is defined by the relation:
L=ρ·Vr·2π·ω·Rp2 (3).

3) Rotating blade body according to claim 1, characterised in that said first sector comprises a smaller base in its most distant point from said axis of rotation of the turbine, having diameter greater than 1/6.5 and smaller than ⅕ of the diameter of the turbine and a greater base nel suo punto più prossimo a in its most close point from said axis of rotation of the turbine, having diameter greater than ⅕ and smaller than ¼ of the diameter of the turbine, said bases being apart from each other by a distance comprised between said diameter and 1.618 times said diameter.

4) Rotating blade body according to claim 1, characterised in that said second sector, connecting said first sector and said axis of rotation of the turbine, comprises a smaller base in its most distant point from said axis of rotation of the turbine and a greater base in its most close point from said axis of rotation of the turbine.

5) Rotating blade body according to claim 1, characterised in that said first sector is derived from a 360° revolution of a symmetrical biconvex NACA profile around its axis of symmetry, or of a plano-convex NACA profile around the straight line passing through the straight portion of the profile, the section with the maximum thickness of which is placed in correspondence of the greater base of said first sector.

6) Rotating blade body according to claim 1, characterised in that said second sector is derived from a 360° revolution of a symmetrical biconvex NACA profile around its axis of symmetry, or of a plano-convex NACA profile around the straight line passing through the straight portion of the profile, the leading section of which is placed in correspondence of the axis of rotation of the turbine.

7) Rotating blade body according to claim 1, characterised in that at the outer end of said first sector an end disc is provided, having a diameter greater than said diameter of the smaller base of said first sector.

8) Rotating blade body according to claim 7, characterised in that said end disc has a diameter comprised between 1.2 and 1.35 times said diameter of the smaller base of said first sector and preferably is equal to 1.3 times said diameter of the smaller base of said first sector.
